(19) United States
(12) Patent Application Publication
(10) Pub. No.: US 2017/0159521 A1
(43) Pub. Date: Jun. 8, 2017

(54) Honeycomb Filter

(71) Applicant: SUMITOMO CHEMICAL COMPANY, LIMITED, Chuo-ku, Tokyo (JP)

(72) Inventors: Tomonari KOBAYASHI, Niihama-shi, Ehime (JP); Osamu YAMANISHI, Tsukuba-shi, Ibaraki (JP)

(21) Appl. No.: 15/325,914

(22) PCT Filed: Jul. 1, 2015
(86) PCT No.: PCT/JP2015/068998

§ 371 Date: Jan. 12, 2017

(30) Foreign Application Priority Data
Jul. 16, 2014 (JP) 2014-145935

(51) Int. Cl. F01N 3/022; B01D 46/24

(52) U.S. Cl. CPC F01N 3/0222; B01D 46/247; B01D 2046/2481; B01D 2046/2496

(57) ABSTRACT

There is provided a porous honeycomb filter. When gas is supplied to the inlet side flow channels from the inlet side end face, the filter satisfies Expression (1), where at each position in a surface of an inner wall of the inlet side flow channel, a gas flow rate in a direction perpendicular to the surface is V, an average of V is V_{AV}, a value of V/V_{AV} at a position with a cumulative frequency of 10% when a distribution of V/V_{AV} is arranged in ascending order is VV₁₀, and a value of V/V_{AV} at a position with a cumulative frequency of 90% when the distribution of V/V_{AV} is arranged in ascending order is VV₉₀,

VV₉₀−VV₁₀≧0.4 (1).

### TECHNICAL FIELD

The present invention relates to a honeycomb filter.

### BACKGROUND ART

A honeycomb filter is used for a filter for removing a substance to be collected from a fluid containing the substance to be collected, and is used as an exhaust fumes filter for cleaning (e.g. collection of soot) exhaust fumes to be discharged from an internal combustion engine such as a diesel engine and a gasoline engine, for example. This kind of honeycomb filter includes a large number of inlet side flow channels and outlet side flow channels that are partitioned by porous ceramic partition walls so as to be parallel to each other (refer to Patent Literature 1 below, for example).

As the honeycomb filter collects soot, pressure loss required for passing gas increases due to a deposition of the soot. Thus, when the soot is collected in the filter to some extent, the soot needs to be removed from the honeycomb filter by being burned.

### CITATION LIST

### Patent Literature

Patent Literature 1: Japanese Unexamined Patent Publication No. 2009-537741

### SUMMARY OF INVENTION

### Technical Problem

Many of conventional honeycomb filters each have a deposition of soot with uniform thickness in an inlet side flow channel, and thus when the soot is burned, combustion uniformly develops. As a result, a maximum reached temperature of the filter may be too high at the time. In contrast, when the soot is non-uniformly deposited in the inlet flow channel, it takes time to burn the soot in a portion with a thick deposition of the soot. Meanwhile, combustion finishes early in a portion with a thin deposition of the soot. As a result, there is caused a time difference in progress and completion of combustion, and a combustion rate is reduced as a whole. Thus, as compared with a case where the soot is uniformly deposited, a maximum readied temperature of the filter can be reduced. However, a honeycomb filter enabling a non-uniform deposition of soot as described above is unknown.

The present invention is made in light of the above-mentioned circumstances, and an object thereof is to provide a honeycomb filter capable of non-uniformly depositing soot in an inlet flow channel.

### Solution to Problem

A honeycomb filter according to the present invention is a porous honeycomb filter including a plurality of inlet side flow channels each having an opening on an inlet side end face and a closed portion on an outlet side end face, and a plurality of outlet side flow channels each having an opening on the outlet side end face and a closed portion on the inlet side end face. When gas is supplied to the plurality of inlet side flow channels from the inlet side end face, Expression (1) below is satisfied, where at each position in a surface of an inner wall of the inlet side flow channel, a gas flow rate in a direction perpendicular to the surface is designated as V, an average of V is designated as V_{AV}, a value of V/V_{AV} at a position with a cumulative frequency of 10% when a distribution of V/V_{AV} is arranged in ascending order is designated as VV₁₀, and a value of V/V_{AV} at a position with a cumulative frequency of 90% when the distribution of V/V_{AV} is arranged in ascending order is designated as VV₉₀,

VV₉₀−VV₁₀≧0.4 (1).

According to the present invention, a variation of gas flow rates V in a direction perpendicular to the surface of the inner wall of the inlet side flow channel is a predetermined value or more. Soot often has a size of 0.5 mm or less, and in this case, movement of the soot depends on a gas flow. As a result, an amount of soot to be collected in the inner wall of the inlet side flow channel can be unevenly distributed.

In a section perpendicular to a direction in which the inlet side flow channel and the outlet side flow channel extend, a surface of at least one of the inlet side flow channels has asperities, and Expression (2) below can be satisfied, where a minimum thickness of a partition wall between the inlet side flow channel and the outlet side flow channel is designated as Dₘᵢₙ, and a maximum thickness of the partition wall between the inlet side flow channel and the outlet side flow channel is designated as Dₘₐₓ,

Dₘₐₓ/Dₘᵢₙ≧1.2 (2)

In addition, a total of a surface area of the inner wall of each of the plurality of inlet side flow channels can be 1.2 m² or more per an apparent volume of 1L of the honeycomb filter.

At least one of the inlet side flow channels is adjacent to the N (N is 2 or more) outlet side flow channels through respective N partition walls, and Expression (3) below can be satisfied, where thickness of each of the N partition walls is designated as Tₙ (n is an integer from 1 to N), a minimum value in the thicknesses Tₙ is designated as Tₘᵢₙ, and a maximum value in the thicknesses Tₙ is designated as Tₘₐₓ,

Tₘₐₓ/Tₘᵢₙ≧1.2 (3).

### Advantageous Effects of Invention

According to the present invention, the honeycomb filter capable of non-uniformly depositing soot in the inlet, flow channel is provided.

### BRIEF DESCRIPTION OF DRAWINGS

FIG. 1 is a sectional view of a honeycomb filter according to a first embodiment of the present invention, taken along an axis of the honeycomb filter.

FIG. 2 is an end view along line II-II in FIG. 1.

FIG. 3 is an end view along line III-III in FIG. 1.

FIG. 4 is a sectional view taken along line IV-IV in FIG. 1.

FIG. 5 is a vertical sectional view of a honeycomb filter according to a second embodiment of the present invention.

FIG. 6 is a vertical sectional view of a honeycomb filter according to a third embodiment of the present invention,

FIG. 7 is a flow chart of a simulation method for acquiring time change of a gas flow rate and a spatial distribution of soot concentration of a honeycomb filter.

FIGS. 8(a), 8(b), and 8(c) are vertical sectional views illustrating honeycomb filters according to comparison calculation examples 1, 2, and 3, respectively.

FIG. 9 is a graph showing values of VV₉₀−VV₁₀ of the calculation examples 1 to 3, and calculation comparative examples 1 to 3.

FIG. 10 is a graph showing values of RR₉−RR₁₀ of the calculation examples 1 to 3, and the calculation comparative examples 1 to 3.

FIG. 11 is a graph showing cumulative frequencies of V/V_{AV} according to the calculation examples 2 and 3, and the comparison calculation example 3.

### DESCRIPTION OF EMBODIMENTS

Hereinafter, embodiments of the present invention will be described in detail with reference to accompanying drawings as needed. However, the present invention is not limited to the embodiments below. In the drawings, the same element is designated by the same reference numeral so that description on the element is not duplicated. In addition, a dimension ratio of the drawings is not limited to a ratio illustrated.

### First Embodiment

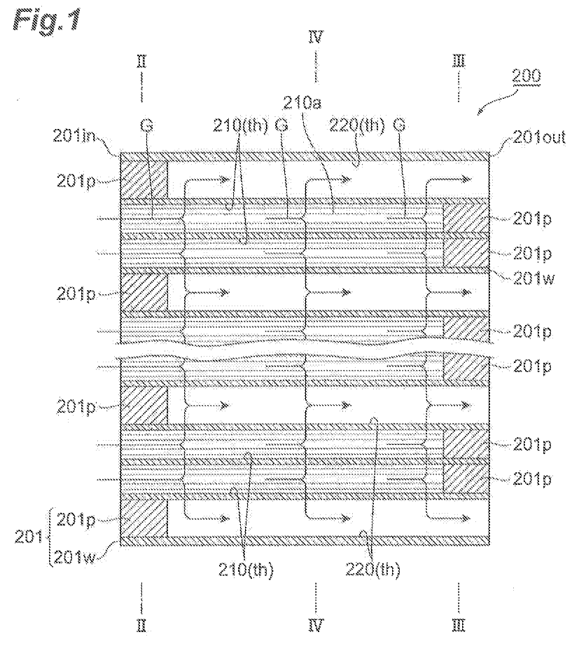

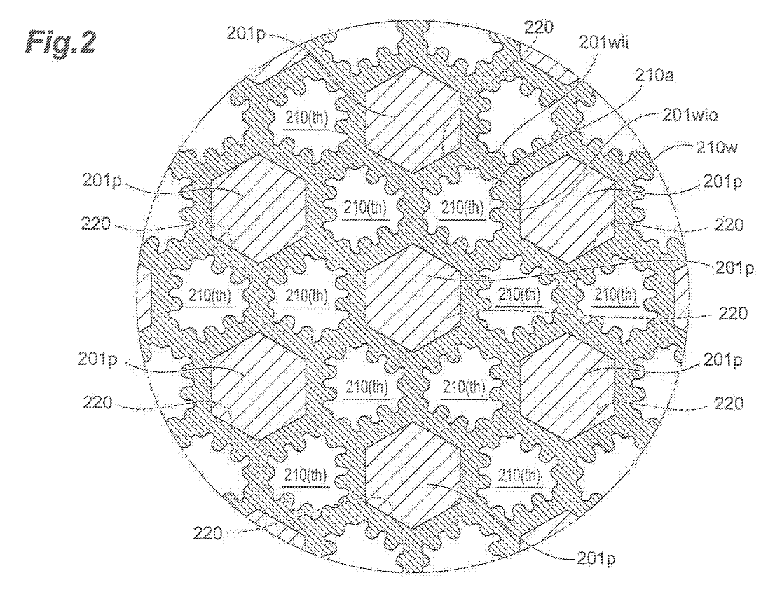

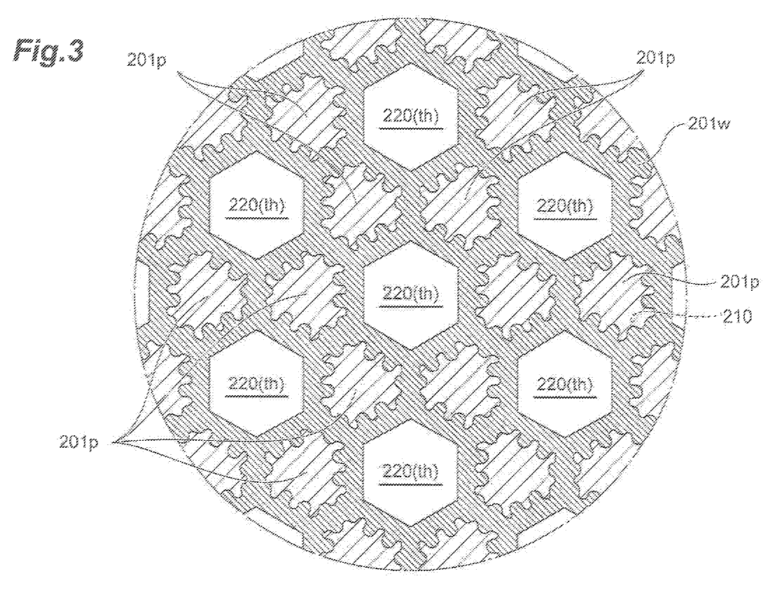

FIG. 1 is a sectional view of a honeycomb filter 200 according to a first embodiment of the present invention, taken along an axis of the honeycomb filter 200, and FIGS. 2 to 4 are respectively enlarged views of an inlet side end face 201 in of the honeycomb filter 200 of FIG. 1, an outlet side end face 20l out thereof, and a cross section at a central portion in an axial direction thereof.

As illustrated in FIG. 1, the honeycomb filter 200 includes a columnar ceramic honeycomb structure 201 provided with an inlet side end face (one end face) 201in and an outlet side end face (the other end face) 201out. The ceramic honeycomb structure 201 includes porous ceramic partition walls 201w extending nearly parallel to each other in its axial direction, or between the inlet side end face 201in and the outlet side end face 201out, to constitute a large number of through-holes th, and closed portions 201p blocking any one of ends of each of the through-hole th. As illustrated in FIGS. 1 to 3, blocking outlet side end faces 201out of a part of the through-holes th by the closed portions 201p forms a plurality of inlet side flow channels (first flow channels) 210in which the inlet side end face 201in is opened and the outlet side end race 201out is closed. In addition, blocking the inlet side end faces 201in of residual through-holes th by the closed portions 201p forms a plurality of outlet side flow channels (second flow channels) 220 in which the outlet side end face 201out is opened and the inlet side end face 201in is closed.

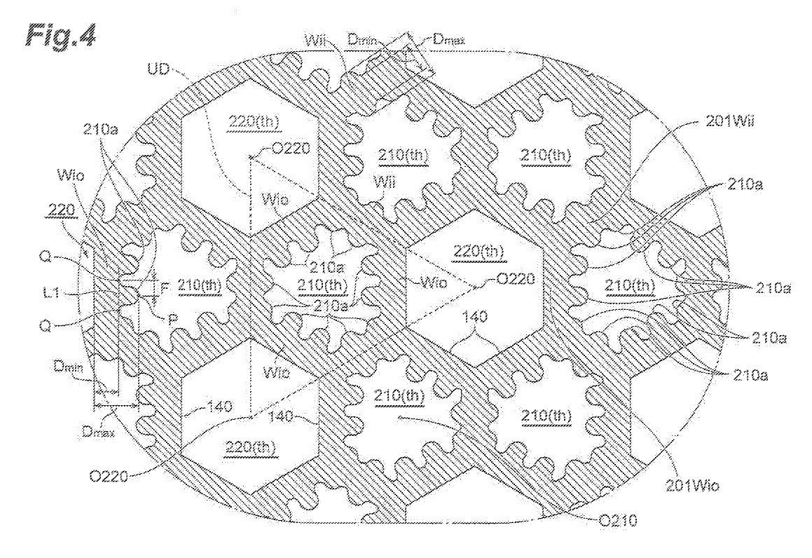

In the present embodiment, as illustrated in FIG. 4, each of the inlet side flow channels 210 is adjacent to other three inlet side flow channels 210 arranged across a partition wall portion constituting each of the inlet side flow channels 210, as well as adjacent to three outlet side flow channels 220 arranged across a partition wall portion constituting each of the inlet side flow channels 210. Meanwhile, each of the outlet side (low channels 220 is adjacent to six inlet side flow channels 210 arranged across a partition wall portion constituting each of the outlet side flow channels 220. The outlet side flow channel 220 is not adjacent to another outlet side flow channel 220 arranged across a partition wall portion constituting the outlet side flow channel 220.

As illustrated in FIG. 4, a section of the outlet side flow channel 220, substantially perpendicular to its axial direction (longitudinal direction), has a hexagonal shape. While it is preferable that a sectional shape of the outlet side flow channel 220 is a regular hexagonal shape having six sides 140 each with substantially equal length from a viewpoint of facilitating reduction in pressure loss when a substance to be collected is deposited by allowing a fluid containing the substance to be collected to evenly and easily flow to one outlet side flow channel 220 from six inlet side flow channels 210, a hexagonal shape having sides each with a length different from each other, and/or a hexagonal shape having an angle other than 60°, are available.

In the present embodiment, an inner surface of the inlet side flow channel 210 is provided with asperities having a large number of projecting portions 210a extending in an axial direction of the inlet aide flow channel 210, as illustrated in FIGS. 1 and 4. As illustrated in FIG. 4, in the present embodiment, a plurality of projecting portions 210a is provided in a surface of the inlet side flow channel 210, in a partition wall portion 201wio separating the inlet side flow channel 210 and the outlet side flow channel 220, as well as a plurality of projecting portions 210a is provided on both sides of a partition wall portion 201wii separating the inlet side flow channel 210 and another inlet side flow channel 210. The partition wall portion 201Wii is a corrugated partition wall provided with projecting portions on both sides of the wall, and the partition wall portion 201Wio is a corrugated partition wall with one face being flat and the other face having projecting portions. In the present embodiment, each partition wall portion 201wio is provided with two projecting portions 210a.

A maximum thickness of the partition wall portion 201Wio can be defined as a distance between an apex P of the projecting portion 210a and an inner wall of the outlet side flow channel 220. In addition, a minimum thickness Dₘᵢₙ of the partition wall portion 201Wio can be defined as a distance between bottom points Q of two recessed portions on both sides of the projecting portions 210a and the inner wall of the outlet side flow channel 220.

While being not particularly limited, Dₘᵢₙ and Dₘₐₓ can be set at from 0.12 to 0.4 mm, and at from 0.2 to 1.0 mm, respectively. In addition, Dₘₐₓ/Dₘᵢₙ≧1.2 can be satisfied. Dₘₐₓ/Dₘᵢₙ also can be 1.5 or more, 1.8 or more, or 1.9 or more. Dₘₐₓ−Dₘᵢₙ can be from 0.05 to 0.6 mm.

While a distance between the projecting portions 210a is not particularly limited, it is preferable that, a distance F between the apex P being the apex of the projecting portion and the point Q being the bottom of the recessed portion, the distance F being along a straight line LI connecting points Q to each other measured, is from 0.08 to 0.4 mm.

While a surface of the inlet side flow channel of the partition wall portion 201Wii is not necessarily a corrugated shape, the partition wall portion 201Wii can have the maximum thickness Dₘₐₓ, the minimum thickness Dₘᵢₙ, (Dₘₐₓ/Dₘᵢₙ), and the like, same as those of the partition wall portion 201Wio when the surface has a corrugated shape.

In the present embodiment, a summation S of an area of an inner surface of the inlet side flow channel 210 in the entire volume of the ceramic honeycomb structure can be 1.2 m²/L, or from 1.5 to 2.5 m²/L. Number density (cell density) of a total number of the inlet side flow channels 210 and the outlet side flow channels 220 can be 150 to 350 per square inch in a section perpendicular to an axis of the ceramic honeycomb structure 201. A unit of the number density is also described as cpsi.

The area of the inner surface of the inlet side flow channel 210 can be acquired by multiplying a length LL of a contour in a section perpendicular to an axis of the inlet side flow channel 210 by a length of the inlet side flow channel 210 in its axial direction, for example. The entire volume of the ceramic honeycomb structure indicates the entire volume of all spaces constituting the structure, including spaces, partition walls, and closed portions of the flow channel.

This kind of honeycomb filter can satisfy Expression (1) below when gas is supplied to the plurality of inlet side flow channels 210 from the inlet side end face 201in.

VV₉₀−VV₁₀≧0.4 (1)

Here, at each position in the surface of the inner wall of the inlet side flow channel 210, a gas flow rate in a direction perpendicular to the surface is designated as V, an average of V is designated as V_{AV}a value of V/V_{AV} at a position with a cumulative frequency of 10% when a distribution of V/V_{AV} is arranged in ascending order is designated as VV₁₀, and a value of V/V_{AV} at a position with a cumulative frequency of 90% when the distribution of V/V_{AV} is arranged in ascending order is designated as VV₉₀.

A lower limit value of VV₉₀−VV₁₀ can be 0.5, 0.6, 0.7, 0.8, 0.9, 1.0, or 1.1. When a shape of a honeycomb filter is determined, a value of VV₉₀−VV₁₀ can be evaluated by computer simulation, for example. In the present embodiment, it can be thought that a unit domain UD illustrated in FIG. 4 is repeatedly arranged. The unit domain UD is a triangle connecting the center of gravity point O220 of each of the outlet side flow channels 220. An example of the simulation method will be described later.

A length of the honeycomb filter 200 in its axial direction is from 50 to 300 mm, for example. An outer diameter of the honeycomb filter 200 is from 50 to 250 mm, for example.

A porosity of the porous ceramic partition wall 201w is preferably 30 volume % or more from a viewpoint of reducing pressure loss, is more preferably 40 volume % or more, and is further preferably 50 volume % or more. The porosity of the porous ceramic partition wall 201w is preferably 80 volume % or less from a viewpoint of reducing heat stress to be generated in the honeycomb filter during combustion regeneration, and is more preferably 70 volume % or less. The porosity of the porous ceramic partition wall 201 w is adjustable by a particle diameter of raw material, an additive amount of a pore forming agent, a kind of pore forming agent, and burning conditions, and can be measured by a mercury intrusion method, for example.

A pore diameter (small hole diameter) of the porous ceramic partition wall 201w is preferably 5 μm or more from a viewpoint of reducing pressure loss, and is more preferably 10 μm or more. The pore diameter of the porous ceramic partition wall 201w is preferably 30 μm or less from a viewpoint of increasing collection performance of soot, and is more preferably 25 μm or less. The pore diameter of the porous ceramic partition wall 201w is adjustable by a particle diameter of raw material, an additive amount of a pore forming agent, a kind of pore forming agent, and burning conditions, and can be measured by a mercury intrusion method, for example.

Ceramic is not particularly limited, and can be composed of mainly aluminium titanate. In this case, the ceramic can further contain magnesium and/or silica. The ceramic also can be composed of mainly cordierite, or can be composed of mainly silicon carbide.

The honeycomb filter described above, for example, is suitable for a particulate filter for collecting soot contained in exhaust fumes from an internal combustion engine such as a diesel engine and a gasoline engine. For example, in the honeycomb filter 200, gas G supplied to the inlet side flow channel 210 from the inlet side end face 201in passes through communication holes in the partition wall to reach the adjacent outlet side flow channel 220, and then is discharged from the outlet side end face 201out, as shown in FIG. 1. At this time, substances to be collected, contained in the gas G are collected in a surface of the inlet side flow channel 210 and in the communication hole to be removed from the gas G, and thus the honeycomb fitter 200 functions as a filter.

According to the honeycomb filter in accordance with the present embodiment, satisfying Expression (1) or VV₉₀−VV₁₀≧0.4, enables a deposition rate of soot at each point in the inlet side flow channel 210 to be non-uniform to some extent. Thus, during regeneration, when soot deposited by increasing oxygen in gas, for example, is burned, it takes time to burn the soot in a portion with a thick deposition of soot, meanwhile combustion finishes early in a portion with a thin deposition of soot, thereby causing progress and completion of combustion to be non-uniform to reduce a combustion rate as a whole. Thus, as compared with a case where the soot is uniformly deposited, a maximum reached temperature of the filter can be reduced. As a result, thermal breakage of the filter during regeneration can be prevented.

### Second Embodiment

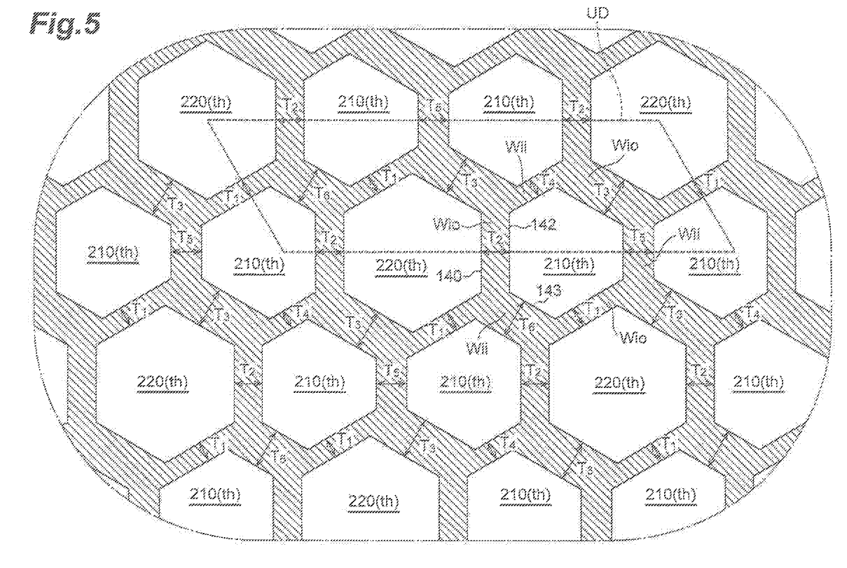

FIG. 5 is a sectional view of a honeycomb filter according to a second embodiment taken at a central portion in its axial direction. The honeycomb filter of the present embodiment is different from that of the first embodiment in the shape of a partition wall portion. Specifically, each of an inner surface of an outlet side flow channel 220 and an inner surface of an inlet side flow channel 210 has no projecting portion, and each of a partition wall portion Wio and a partition wall portion Wii has a fiat-shaped partition wall in the shape of a flat plate.

A cross-sectional shape of the outlet side flow channel 220 is a substantially regular hexagon as with the first embodiment. A cross-sectional shape of the inlet aide flow channel 210 is a hexagon, and a length of a side 142 facing one of sides of the outlet side flow channel 220 is substantially equal to a length of a side 140 of the regular hexagon of the outlet side flow channel 220. A length of a side 143 facing one of sides of the inlet side flow channel 210 is shorter than the length of the side 142.

While each one inlet side flow channel 210 is adjacent to three outlet side flow channels 220, thickness of each of partition wall portions Wio separating the one inlet side flow channel 210 and the three outlet side flow channels 220 is different from each other. Here, thickness of each of the three partition wall portions Wio each of which is adjacent to the outlet side flow channels 220 and forms the one inlet side flow channel 210 is designated as T₁, T₂, and T₃.

Then, the filter satisfies Expression (2) below:

Tₘₐₓ/Tₘᵢₙ≧1.2 (2)

where Tₘₐₓ is a maximum value in T₁ to T₃, and Tₘᵢₙ is a minimum value in T₁ to T₃.

(Tₘₐₓ/Tₘᵢₙ) can be 1.5 or more, 1.8 or more, or 1.9 or more.

In a case where T₁<T₂<T₃, T₁ or Tₘᵢₙ can be from 0.04 to 1 mm. In addition, T₃ or Tₘₐₓ can be from 0.06 to 1.01 mm.

While each one inlet side flow channel 210 is adjacent to three inlet side flow channels 210, thickness of each of partition wall portions Wii separating the one inlet side flow channel 210 and the three inlet side flow channels 210 can be different from each other. Here, thickness of each of the partition walls Wii is designated as T₄, T₅, and T₅ (T₄<T₅T₆). T₄, T₅, and T₆ can be similar to T₁, T₂, and T₃, respectively.

Even the present embodiment can satisfy Expression (1), or VV₉₀−VV₁₀≧0.4, and thus an effect as with the first embodiment can be acquired.

In the present embodiment, it can be thought that a unit domain UD indicated by a dotted line in FIG. 5 is repeatedly arranged, and thus VV₉₀ and VV₁₀ can be calculated by computer simulation for the unit domain.

### Third Embodiment

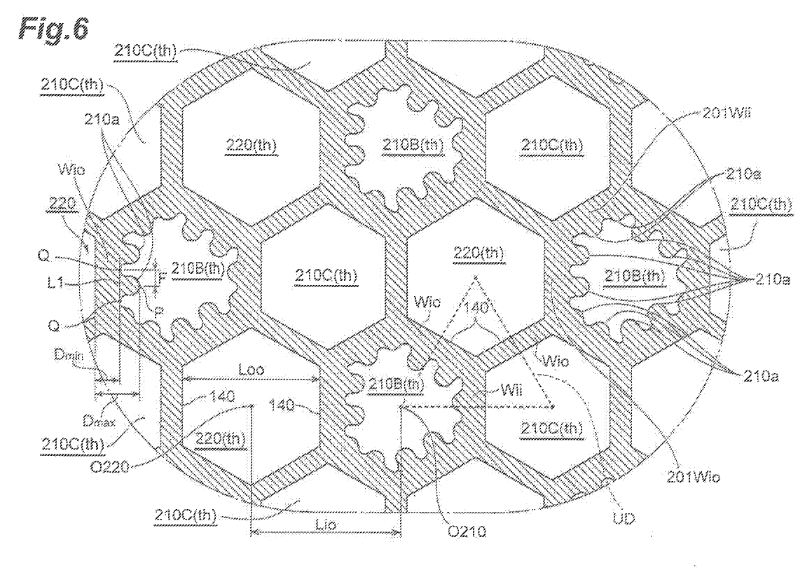

FIG. 6 is a sectional view of a honeycomb filter according to a third embodiment taken at a central portion in its axial direction. The honeycomb filter of the present embodiment is different from that of the first embodiment in that an inlet side flow channel 210 has two kinds of shape of an inlet side flow channel 210B and an inlet side flow channel 210C.

The inlet side flow channel 210B is the same as the inlet side flow channel 210 of the first embodiment. The inlet side flow channel 210C has no asperity, and is a hexagonal tube formed of six planes. Thickness of a partition wall portion Wio separating the inlet side flow channel 210C and an outlet side flow channel 220 can be a substantially median value between the maximum thickness Dₘₐₓ and the minimum thickness Dₘᵢₙ of the partition wall between the inlet side flow channel 210B and the outlet side flow channel 220 described above. A preferable range is not less than 1.05×Dₘᵢₙ and not more than 0.95×Dₘₐₓ.

The inlet side flow channel 210B is adjacent to three outlet side flow channels 220 and three inlet side flow channels 210C. The inlet side flow channel 210C is adjacent to three outlet side flow channels 220 and three inlet side flow channels 210B. Even the present embodiment can satisfy VV₉₀−VV₁₀≧0.4, and thus an effect as with the first embodiment can be acquired.

In addition, as illustrated in FIG. 6, the inlet side flow channel 210B and the inlet side flow channel 210C are alternately arranged around the outlet side flow channel 220 so as to be adjacent to the outlet side flow channel 220. The inlet side flow channel 210B and the inlet side flow channel 210C are different from each other in cross-sectional shape, and thus have pressure loss different from each other. As a result, an amount of gas flowing into each of the channels as well as an amount of deposition of soot of each of the channels is different from each other. If two inlet side flow channels each with a different deposition state of soot are evenly distributed in the honeycomb filter as described above, temperature distribution in the filter during regeneration can be reduced.

In the present embodiment, it can be thought, that a unit domain UD indicated by a dotted line in FIG. 6 is repeatedly arranged, and thus VV₉₀ and VV₁₀ can be calculated by computer simulation for the unit domain.

The honeycomb filter of each of the embodiments described above can be manufactured by the steps including: (a) a raw material preparation step of preparing a raw material mixture containing a ceramic raw material powder and a pore forming agent; (b) a molding step of molding the raw material mixture to acquire a molded article having an inlet side (low channel and an outlet side flow channel; and (c) a burning step of burning the molded article. The molded article before being closed, that is, the molded article provided with through-holes th without forming the inlet side flow channel and the outlet side flow channel can be fired, and then the burned article may be closed to form the inlet side flow channel and the outlet side flow channel.

The present invention is not necessarily to be limited to the embodiments described above, and various modifications are possible within a range without departing from the essence of the present invention.

For example, in the honeycomb filter 200, a cross-sectional shape and/or arrangement of each of the inlet side flow channel 210 and the outlet side flow channel 220 are not limited to those described above if VV₉₀−VV₁₀≧0.4 is satisfied.

For example, while the second embodiment is configured to allow one inlet side flow channel to be adjacent to three outlet side flow channel through each partition wall, the second embodiment can be configured to allow one inlet side flow channel to be adjacent to two outlet side flow channels or four or more outlet side flow channels through each partition wall. When one inlet side flow channel is adjacent to N (N is an integer of 2or more) outlet side flow channels through each partition wall, Expression (3) can be satisfied, where thickness of each partition wall is designated as Tₙ (n is an integer from 1 to N), a minimum value in die thicknesses Tₙ is designated as Tₘᵢₙ, and a maximum value in the thicknesses Tₙ is designated as Tₘₐₓ.

The corrugated shape in each of the first and third embodiments may have a variety of sizes and numbers.

The cross-sectional shape of each of the inlet side flow channel and the outlet side flow channel also is not limited to a hexagon, and may be formed in a variety of shapes such as a quadrilateral, an octagon, a circle, and an ellipse. In addition, the shape of asperities of the partition wall also may be changed.

A closing method is not limited to a mode of plugging one end of a through-hole with a closed portion, and there is also available a mode of expanding diameters of through-holes that are not be closed, provided around a through-hole to be closed, to squeeze a partition wall of the through-hole to be closed to close one end of the through-hole.

An outline shape of the filter also is not particularly limited to a column if being a pillar shape, and may be a rectangular pillar, for example.

In addition, Dₘₐₓ/Dₘᵢₙ≧1.2 may not be satisfied in each of the inlet side flow channels 210 and 210B in the first and third embodiments, and there is also available a configuration in which an inner surface of at least one of the inlet side flow channel 210 or 210B has asperities and Dₘₐₓ/Dₘᵢₙ≧1.2 is satisfied, for example.

In the second embodiment, a relationship of Tₘₐₓ/Tₘᵢₙ≧1.2 may not be satisfied in each inlet side flow channel 210, and there is also available a configuration in which Tₘₐₓ/Tₘᵢₙ≧1.2 is satisfied in at least one inlet side flow channel 210, for example.

While the present invention is further described below in detail by using calculation examples, the present invention is not limited to the calculation examples.

### CALCULATION EXAMPLES 1 to 3, and COMPARISON CALCULATION EXAMPLES 1 to 3

Distribution of a gas (low rate V perpendicular to a surface at each point in the inlet side flow channel was acquired by computer simulation for each of six honeycomb filters shown in Tables 1 and 2 to acquire VV₉₀−V₁₀. In addition, distribution of a deposition rate of soot at each point was also acquired.

(Simulation Method)

First, the mass and the momentum conservation equations are solved to acquire the gas flow rate V of gas in three dimensions in the filter.

∂ρ/∂t+Δ·(ρV)=0 (C1)

∂(ρV)∂t+Δ·(ρVV)=−Δp+μΔ²V+S (C2)

Here, ρ is gas density, t is time, p is pressure, μ is viscosity, and S is momentum loss of gas caused by a filter or soot. It is possible to apply ρ and μ as physical properties of the gas, ρ and μ are 1.2 kg/m³ and 1.0×10⁻⁶ Pa·s, respectively. S is applied based on a measured value using a simple plate-like ceramic body.

Expressions (C1) and (C2) can be calculated by convergence calculation performed by a computer using a publicly known method.

Since soot content is 1% or less in exhaust fumes of an engine, and the like, as well as a size of soot is 0.5 mm or less, it is rational to assume that soot completely follows the gas flow rate V. Thus, soot concentration φ can be expressed by the following Expression, where ρₛ is density of soot.

∂(ρₓφ)/∂t+Δ·(ρₛφV)=0 (C3)

Here, ρₛ was 2000 kg/m³.

Substituting V acquired above into Expression (C2) enables a three-dimensional distribution of soot concentration φ to be acquired.

A calculation domain was set as the unit domain UD described in each drawing. Velocity of soot was set so as to be zero at a surface of the filter. In addition, S was changed with time as soot was deposited. Unsteady calculation was performed where a gas flow rate to be supplied per unit area (1 m²) in the inlet side end face 201in of the honeycomb filter is 5.89 kg/s, soot concentration is 6.5×1⁻⁴ wt %, and gas temperature is 28.7 °C.

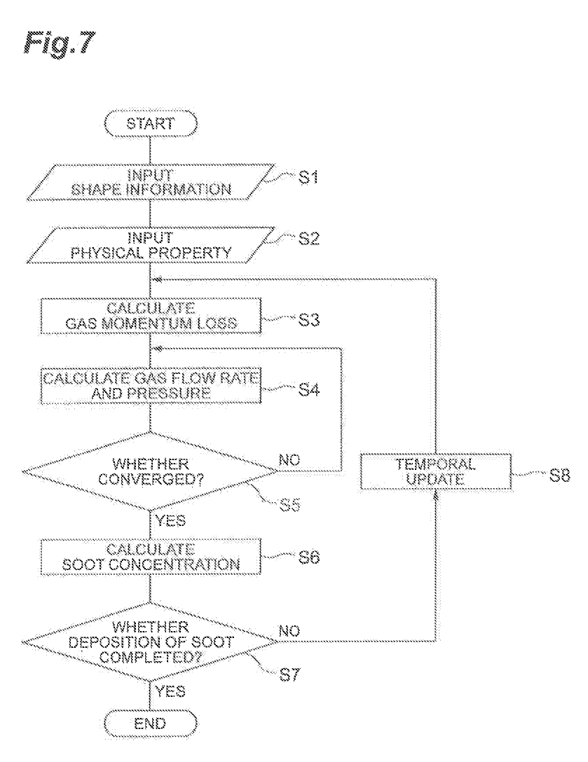

A flow chart of the calculation is illustrated in FIG. 7.

In step S1, shape information on a calculation domain is inputted, and in step S2, parameters, such as ρ, ρₛ , and μ, required for the calculation is inputted.

Next, in step S3, S is calculated. In step S4, V is acquired based of Expressions (C1) and (C2). In step S5, it is determined whether V and p converge, and when they do not converge, processing returns to step S4 to allow V and p to converge. After V and p converge, in step S6, soot concentration φ is acquired based on Expression (C3) and V acquired. In step S7, when an amount of deposition of soot per unit volume of the filter does not reach a predetermined amount, time is increased by Δt in step S8, and the processing returns to step S3. In step S7, when the amount of deposition of soot per unit volume of the filter reaches the predetermined amount, and the calculation is finished.

Then, VV₉₀−VV₁₀ was acquired according to the definition described above. V_{AV} was an average of all surfaces of the inlet side flow channels. Specifically, since the amount of deposition of soot increases with time, V and VV₉₀−VV₁₀ also change with time. According to preliminary calculation, in a state where the amount of deposition of soot per unit volume (1 L) of the filter is less than 0.1 g, there was a maximum difference in a value of VV₉₀−VV₁₀ among the respective calculation examples and the respective comparison calculation examples. Thus, in step S7, when the amount of deposition of soot was 10⁻⁴ g/L, the calculation was finished, and a value of VV₉₀−VV₁₀ acquired based on the gas flow rate V at the time was adopted. While the present example used unsteady simulation including particles, VV₉₀−VV₁₀ can be simply evaluated by even steady simulation without particles because particle concentration is low, and thus tendency as with the unsteady simulation can be acquired.

In addition, a deposition rate R of soot at each point in a surface of the inlet side flow channel was acquired based on time change of soot concentration φ at each point in the surface of the inlet side flow channel. Then, RR₉₀−RR₁₀ was acquired. Here, when an average of R of all surfaces was designated as R_{AV} and a distribution of R/R_{AV} was arranged in ascending order, a value of R/R_{AV} at a position with a cumulative frequency of 10% was designated as R/R₁₀. When the distribution R/R_{AV} was arranged in ascending order, a value of R/R_{AV} at a position with a cumulative frequency of 90% was designated as RR₉₀.

### Calculation Examples 1 to 3

A calculation example 1 is a shape of a flow channel corresponding to the first embodiment, a calculation example 2 is a shape of a flow channel corresponding to the second embodiment, and a calculation example 3 is a shape of a flow channel corresponding to the third embodiment. The unit domain UD calculated is illustrated in each of FIGS. 4, 5, and 6. Detailed conditions of a cell are shown in Tables 1 and. 2.

### Comparison Calculation Examples 1 to 3

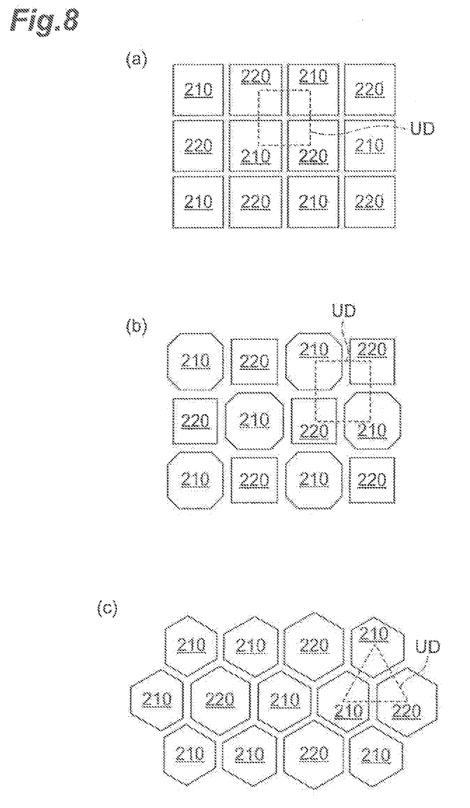

A comparison calculation example 1 has a form of FIG. 8(a) so-called a square cell, that is, the inlet side flow channel 210 and the outlet side flow channel 220 each have a square cross-section, and four outlet side flow channels 220 are adjacent to the inlet side flow channel 210.

A comparison calculation example 2 has a form of FIG. 8(b) so-called an octagon cell, that is, the inlet side flow channel 210 has an octagonal cross-section and an outlet side flow channel has a square cross-section, and four outlet side flow channels 220 and four inlet side flow channels 210 are adjacent to the inlet side flow channel 210.

A comparison calculation example 3 has a form of FIG. 8(c) in which the inlet side flow channel 210 has a hexagonal cross-section and an outlet side flow channel has a hexagonal cross-section, and three outlet side flow channels 220 and three inlet side flow channels 210 are adjacent to the inlet side flow channel 210. The unit domain UD calculated is illustrated in FIG. 8.

TABLE 1

| | | | | | | Comparison | Comparison | Comparison |
|---|---|---|---|---|---|---|---|---|
| | | | Calculation | Calculation | Calculation | calculation | calculation | calculation |
| | | | example 1 | example 2 | example 3 | example 1 | example 2 | example 3 |
| Cell | Corresponding drawing | | FIG. 4 | FIG. 5 | FIG. 6 | FIG. 8 (a) | FIG. 8 (b) | FIG. 8 (c) |
| structure | Inlet side flow channel shape | | Corrugated | Hexagon | Hexagonal flow | Quadrilateral | Octagon | Hexagon |
| | | | contour | | channel and flow | | | |
| | | | | | channel with | | | |
| | | | | | corrugated contour | | | |
| | | | | | alternately arranged | | | |
| | Corrugated | Minimum thickness between | 0.255 | — | 0.271 | — | — | — |
| | partition | inlet side flow channel and | | | | | | |
| | wall | outlet side flow channel | | | | | | |
| | | Dₘᵢₙ [mm] | | | | | | |
| | | Maximum thickness between | 0.505 | — | 0.546 | — | — | — |
| | | inlet side flow channel and | | | | | | |
| | | outlet side flow channel | | | | | | |
| | | Dₘₐₓ [mm] | | | | | | |
| | | D_{max/}Dₘᵢₙ [—] | 1.98 | — | 2.01 | — | — | — |
| | Flat-shaped | Side length 1 of inlet side | — | 0.618 | 0.537 | 1.27 | 0.383 | 0.618 |
| | partition | flow channel [mm] | | | | | | |
| | wall | Side length 2 of inlet flow | — | 0.895 | 0.97 | — | 1.134 | 0.895 |
| | | channel [mm] | | | | | | |
| | | Maximum value in thickness | — | 0.434 | 0.399 | 0.31 | 0.40 | 0.31 |
| | | between one inlet side flow | | | | | | |
| | | channel and each outlet side | | | | | | |
| | | flow channel adjacent to the | | | | | | |
| | | inlet side flow channel | | | | | | |
| | | T_{max [mm]} | | | | | | |
| | | Minimum value in thickness | — | 0.187 | 0.399 | 0.31 | 0.40 | 0.31 |
| | | between one inlet side flow | | | | | | |
| | | channel and each outlet side | | | | | | |
| | | flow channel adjacent to the | | | | | | |
| | | inlet side flow channel | | | | | | |
| | | T_{min [mm]} | | | | | | |
| | | (T_{max/}Tₘᵢₙ) [—] | — | 2.32 | 1.00 | 1.00 | 1.00 | 1.00 |

TABLE 2

| | | | | | Comparison | Comparison | Comparison |
|---|---|---|---|---|---|---|---|
| | | Calculations | Calculation | Calculation | calculation | calculation | calculation |
| | | example 1 | example 2 | example 3 | example 1 | example 2 | example 3 |
| Cell structure | Corresponding drawing | FIG. 4 | FIG. 5 | FIG. 6 | FIG. 8 (a) | FIG. 8 (b) | FIG. 8 (c) |
| | Outlet side flow channel shape | Hexagon | Hexagon | Hexagon | Quadrilateral | Quadrilateral | Hexagon |
| | Side length of outlet side | 0.970 | 0.895 | 0.970 | 1.27 | 1.327 | 0.895 |
| | flow channel [mm] | | | | | | |
| | Cell density [cpsi] | 220 | 260 | 220 | 260 | 178 | 260 |
| | Filtration area per unit volume | 1.66 | 1.19 | 1.20 | 1.00 | 0.83 | 1.19 |
| | of the filter [m²/L] | | | | | | |
| Gas flow rate | VV₉₀-VV₁₀ [—] | 1.170 | 0.608 | 0.579 | 0.094 | 0.314 | 0.314 |
| evaluation | | | | | | | |
| Soot deposition | RR₉₀-RR₁₀ [—] | 1.16 | 0.627 | 0.463 | 0.109 | 0.323 | 0.329 |
| rate evaluation | | | | | | | |

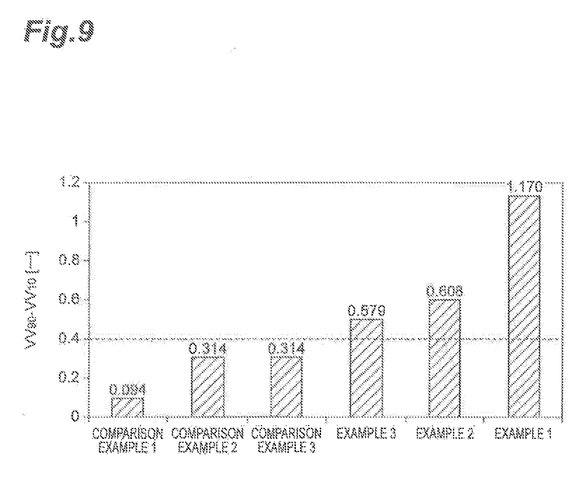

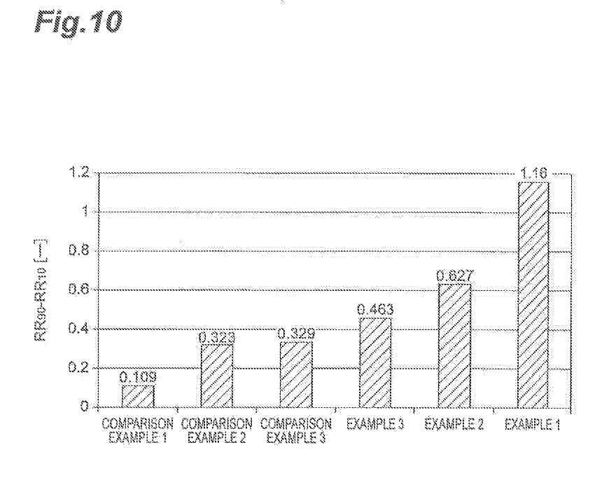

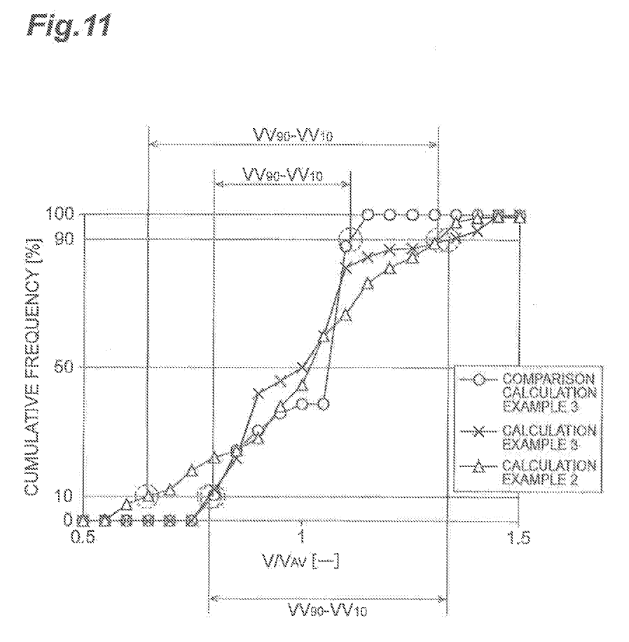

Calculation results are shown in Table 2, calculation results of VV₉₀−VV₁₀ are shown in FIG. 9, values of RR₉₀−RR₁₀ are shown in FIG. 10, and cumulative frequencies of V/V_{AV} of the calculation examples 2 and 3, and the calculation comparative example 3, are shown in FIG. 11. It was found that the honeycomb filters of the calculation examples 1 to 3, satisfying VV₉₀−VV₁₀≧0.4, enabled soot to be non-uniformly deposited.

### REFERENCE SIGNS LIST

200 . . . honeycomb filter, 201in . . . inlet side end face (one end face), 201out . . . outlet side end face (the other end face), 201 . . . ceramic honeycomb structure, 201w . . . porous ceramic partition wall, 201p . . . closed portion, 210 . . . inlet side flow channel (first flow channel), 210a . . . projecting portions, 220 . . . outlet side flow channel (second flow channel)

1. A porous honeycomb filter comprising:
a plurality of inlet side flow channels each having an opening on an inlet side end face and a closed portion on an outlet side end face; and
a plurality of outlet side flow channels each having an opening on the outlet side end face and a closed portion on the inlet side end face,
wherein when gas is supplied to the plurality of inlet side flow channels from the inlet side end face, Expression (1) below is satisfied, where at each position in a surface of an inner wall of the inlet side flow channel, a gas flow rate in a direction perpendicular to the surface is designated as V, an average of V is designated as V_{AV}, a value of V/V_{AV} at a position with a cumulative frequency of 10% when a distribution of V/V_{AV} is arranged in ascending order is designated as VV₁₀, and a value of V/V_{AV} at a position with a cumulative frequency of 90% when the distribution of V/V_{AV} is arranged in ascending order is designated as VV₉₀,
VV₉₀−VV₁₀≧0.4 (1)

2. The honeycomb filter according to claim 1, wherein
in a section perpendicular to a direction in which the inlet side flow channel and the outlet side flow channel extend, a surface of at least one of the inlet side flow channels has asperities, and Expression (2) below is satisfied, where a minimum thickness of a partition wall between the inlet side flow channel and the outlet side flow channel is designated as Dₘᵢₙ, and a maximum thickness of the partition wall between the inlet side flow channel and the outlet side flow channel is designated as Dₘₐₓ,
Dₘₐₓ/Dₘᵢₙ≧1.2 (2)

3. The honeycomb filter according to claim 2, wherein
a total of a surface area of the inner wall of each of the plurality of inlet side flow channels is 1.2 m² or more per an apparent volume of 1 L of the honeycomb filter.

4. The honeycomb filter according to claim 1, wherein
at least one of the inlet side flow channels is adjacent to the N (N is 2 or more) outlet side flow channels through respective N partition walls, and Expression (3) below is satisfied, where thickness of each of the N partition walls is designated as Tₙ (n is an integer from 1 to N), a minimum value in the thicknesses Tₛ is designated as Tₘᵢₙ, and a maximum value in the thicknesses Tₙ is designated as Tₘₐₓ,
Tₘₐₓ/Tₘᵢₙ≧1.2 (3).
